(19) United States
(12) Patent Application Publication
(10) Pub. No.: US 2008/0121525 A1
(43) Pub. Date: May 29, 2008

(54) Renewable Power Controller for Hydrogen Production

(76) Inventor: George J. Doland, Houston, TX (US)

Correspondence Address: GEORGE J. DOLAND, 7026 FAUNA STREET, HOUSTON, TX, 77061-3918, US

(21) Appl. No.: 11/744,232

(22) Filed: May 4, 2007

Related U.S. Application Data
(63) Continuation-in-part of application No. 11/163,249, filed on Oct. 11, 2005, now abandoned.

(51) Int. Cl. H02P 9/00; C02F 1/46

(52) U.S. Cl. 204/661; 322/20; 322/22; 322/29

(57) ABSTRACT

A power controller for electric generation from renewable energy and consumption of said energy, where appropriate, to produce hydrogen. The controller improves overall system efficiency by controlling electricity generation over a wider range of conditions, and by controlling the electric conversion to that required by the hydrogen converter much more efficiently, than systems which consist of independent controllers. An overall systems controller which dynamically optimizes the complete system to maximize the available inputs, such as renewable and stored energy, while providing the maximum desired outputs, such as power, hydrogen and income, taking into account the ultimate capacity of components along with historical, current and predicted future data.

### CROSS REFERENCE TO RELATED APPLICATIONS

This a is a continuation-in-part of my pending U.S. Non-provisional application Ser. No. 11/163,249, filed Oct. 11, 2005, the contents of which are hereby incorporated by reference. Since this applications is filed by the same inventor as is the prior application and its contents are incorporated herein, it has the benefits from and the filing date of the prior application under 37 CFR 1.53(b).

### FIELD OF INVENTION

This invention relates to the production of hydrogen which is specifically produced using renewable energy power electric generation. It addresses improvements in overall performance accomplished by treating the whole process as a single system to maximize the renewable energy captured and to most efficiently produce hydrogen.

### BACKGROUND

Two pieces of background information relate to the understanding of the current state of the art for this invention. First, power is generated and distributed at standard levels. Second, hydrogen generation from electrolysis of water requires control of the energy delivered to the electrolyzer cells.

In the US and many parts of the world, power is generated and distributed to its users on a power grid. On this power grid, there are very specific requirements for electrical parameters such as voltage, frequency, etc. In the USA, the frequency is specified at a tightly controlled 60 hertz. Voltage levels depend on what part of the system is monitored. Distribution on the grid may be 238 kV, 138 kV, 69 kV or some similar voltage. Within a residential distribution area or small commercial park, voltages of 12,470 volts or 13,200 volts can be found. Within a building or home 480 volt, 240 volt or 120 volt systems are typical. This standardization allows manufacturers to design equipment without knowing the specific equipment to which it will be connected.

The same type of standards apply to renewable energy production equipment. For instance on a typical wind farm in the USA which produces electricity for distribution on the power grid, the generator produces electric at 480 or 600 Volts AC, 3 phase, and at that precise 60 hertz. The generators would produce a precise 50 hertz if the farm was in Europe. If individual wind turbines can not produce these precise electrical levels, they are disconnected from the system until enough wind is available to meet these requirements. The individual turbines are connected through transformers to an internal grid which typically operates at 34 kV. The internal grid is then connected to a substation which connects the wind farm to the main US distribution power grid, which usually operates at 138 kV.

Other forms of renewable power generation systems use the same concepts. Solar, wave energy, geothermal and hydroelectric plants use generators that produce power which is adjusted to get the precisely required parameters to connect to an internal power grid. Then at one or more substations the voltage is raised to the level required to connect to the US power distribution grid. The term US power grid is used to represent all of the regional system operators which appear to the public as “the power grid”.

The use of these standard voltage, frequency and other electrical parameters make it easy for interconnection of the components, but in the cases of renewable power generation, in particular, it means that some generation equipment must be adjusted or disconnected because it does not meet the requirements. The result is high nameplate plant capacities which represent the maximum generating capacity of the renewable energy which could be produced under absolutely ideal conditions. In reality, the actual operating capacity factors of these plants are very low (many times below 35%), because of the previously mentioned adjustments and outages. Use of this invention will help raise these capacity factors.

It is observed and known that the conversion of power from one type to another is optimized by matching the source characteristics to the load's characteristics. In radio as in electronic audio, the maximum power transfer occurs when the source impedance matches the output's impedance. We are familiar with making sure that a 4 ohm speaker is used on a 4 ohm amplifier and an 8 ohm on an 8 ohm system. Also in radio applications, the radio's impedance must be matched to the cable and the antenna impedance. In CB and shortwave radio system setup, an SWR meter is used to adjust the impedance matching and improve energy transfer. Likewise, matching the operating characteristic of an engine to a motor vehicle produces the maximum power transfer and performance. A large engine with plenty of low end torque moves large earth moving equipment better than a high revving motocross motorcycle engine. Transmissions are used to improve the energy transfer over a wide range of operating conditions. Most notable is the improved acceleration of an automobile which is in the proper gear. Similarly, how hard is it to start a car in third gear and if one can get it started, how slow is the initial acceleration? The invention makes use of these concepts of matching the primary renewable energy source to the load, which is the hydrogen production equipment.

Another aspect of generating hydrogen from renewable energy requires background in what electricity goes into an electrolyzer cell. In this case, nature specifies some of the requirements. The nature of the process requires specific chemical and physical interactions which require a precise DC voltage to cause hydrogen and oxygen atoms to dissociate in water. The more current used, the more water is broken into its atomic components. Ideally, there would be zero resistance in the electrical components which make up the electrolyzer cells. But in reality there are what is known as IR losses and these require the electrical power supplied to be of slightly higher voltage than nature's ideal level. Mechanical design within the cells attempts to limit these IR losses, but also set practical limits on the maximum current which can be put through a cell. A power converter/controller is used by the electrolyzer to provide the required electrical energy to dissociate the hydrogen and oxygen in the water, compensate for IR losses, and control the rate at which the gasses are generated.

It should be noted that the concepts of using a controller to optimize a network of electric generation, hydrogen production, hydrogen storage and users is already covered under referenced U.S. Pat. Nos. 6,912,450 and 6,745,105. These concepts are mentioned here for illustration purposes only and are not a part of the invention presented here. The renewable power controller presented here is a dynamic, real time, power controller which adjusts or controls the generation of energy from renewable sources, the transmission of energy and the conversion to the electrical requirements (usually DC voltage) of the hydrogen conversion equipment. Historical, current and predicted future data is used to optimize the complete system. For simplicity this invention is referred to as the renewable power controller, the power controller or just the controller throughout this patent.

Another characteristic of the power flow process which is of special note is frequency. As stated earlier, most generating equipment operating in the US operates at 60 hertz. Renewable power generating equipment usually shuts down when it can not produce the required 60 Hz frequency, but this limitation is not necessary for hydrogen production. The power generation equipment can continue to supply energy to hydrogen power conversion equipment even though the frequency may be 30 Hz or 120 Hz. This would allow the system to continue producing hydrogen when a traditional system would be shutdown. Within reason, the frequency of generated power does not effect the hydrogen generation process since the power supplied to the electrolyzer cell is a DC voltage.

The ideal electrical requirements from a renewable energy source used to make hydrogen are also altered by social and economic reasons. We adjust some parameters to meet requirements for hydrogen demand, costs and available raw materials. Here raw materials refers to the availability of water and electricity. For instance, if the tide is coming in for a wave energy plant, so water is available and electricity is plentiful, then while the income for the produced hydrogen is high, the cell current will be raised even though there may be higher IR losses. In contrast, low water and electric availability, combined with low market price for hydrogen, may call for operating the cells at lower current densities or reducing the number of cells operating to produce the hydrogen product.

The renewable power controller operates or controls components of the overall system. The controller either operates components of the system or operates directly on the power as it passes through the controller. Components of the system include; the external generator systems which include steering, cleaning and alignment components; the renewable energy generators; the switchgear which directs energy throughout the system; the energy transmission and storage components; the hydrogen generation/electrolyzer components; hydrogen handling components which condition, compress and store the hydrogen; and social/economic components which input pricing, demand and events data which effect pricing and demand.

Lastly, we are back to the power grid issue. Current electrolyzer systems are designed to operate from the utility power grid. For decades, small laboratory units have been designed and operated from 120/240 VAC power, typically found in a school of higher learning or industrial laboratory. Even large commercial units which produce enough hydrogen to run a refueling station for fuel cell driven automobiles will run on a typical power system level of 480 VAC, 3 phase. These values are chosen because they are the discrete values available in standard applications. They are not the ideal values for maximum hydrogen production. The invention removes the limitations artificially imposed to meet standard available power, and maximizes the hydrogen produced during generation of any available power.

### SUMMARY

The invention embodies a control apparatus for a system having:
1. A source of renewable energy such as but not limited to solar, wind, hydro, geothermal, and wave energies.
2. One or more electric energy generators
3. One or more electrolyzers
4. Data measurement, storage and analyzing equipment
5. Said renewable power control apparatus is used to manage the generation, energy transmission and conversion of energy to hydrogen.

In accordance with the invention, electric power is generated from the renewable energy source. The electric power is to provide energy to an electrolyzer. The electrolyzer is used to disassociate water into hydrogen and oxygen. The hydrogen is then transported to a fuel consumer or stored for future use.

An object of the invention is to provide an overall improvement in efficiency of hydrogen production from renewable energy sources.

An object of this invention is to improve the control and use of intermittent and varying renewable energy sources for the purpose of better plant utilization when producing hydrogen.

An object of the invention is to provide a greater capacity factor for renewable electric energy generating systems.

An object of the invention is to provide reduced energy losses in electrolyzer electric power control systems.

An object of the invention is to provide an efficient and reliable method of supplying hydrogen fuel to replace fossil fuels, and to do so using clean, renewable energy sources.

An object of the invention is to provide a means to efficiently store the energy produced from renewable sources.

### BRIEF DESCRIPTION OF THE DRAWINGS

The drawings depict various arrangements of the invention, not to limit but rather to illustrate some possible arrangements which include:

FIG. 1 shows the basic block diagram showing an arrangement of several renewable energy generators powering a hydrogen production system consisting of several electrolyzers and employing the invention's renewable power controller,

FIG. 2 is illustrative of a wave powered generator as the renewable power source and it also illustrates how the described invention's controller can provide the function of AC to DC conversion and power control for the electrolyzer,

FIG. 3 is illustrative of a wind turbine generator (WTG) as the renewable power source and it illustrates how the renewable power controller can be used as a supervisory or master controller to optimize the WTG's output while the same master/slave arrangement is shown on the electrolyzer power controls,

FIG. 4 is illustrative of a system which consists of several renewable energy sources including grid connected power lines, which can both supply power to the system and can return renewable power generated by the system to the power grid, and it also shows an internal power grid or buss which can supply power from multiple sources to the electrolyzer cells.

### DETAILED DESCRIPTION OF THE INVENTION

FIG. 1 depicts a schematic block diagram of one embodiment of the invention having renewable energy source 10 supplying energy to renewable energy electric generators 11. The diagram uses three generators for the purpose of illustration only. The electric generators 11 can be of any type suitable to harness the supplied energy. These generators can include, but are not limited to; photovoltaic, solar sterling, solar thermal, wind turbine, wave, ocean current, nuclear, bio-mass, etc. The output of the generator 11 is electrical energy 12 which supplies power to at least one electrolyzer cell 30.

The electrolyzer cell(s) 30 take water 50 via conduit 51 into the cell. The electrolyzer cell(s) use electrical power 12 to split the water molecules and produce hydrogen 40. The hydrogen 40 is then conveyed or transported for use. The hydrogen 40 can be kept in storage containers 61 for future use. The hydrogen 40 can be supplied to a new or existing distribution system network 62 which can distribute hydrogen to many different users. The hydrogen can be used to generate electrical power using any number of different types of electrical power generators 63. These include, but are not limited to steam turbines, hydrogen powered gas turbines or even fuel cells. Hydrogen storage 61 can be combined with power generators 63 to produce a system which appears to store clean renewable electrical power. The hydrogen 40 can also be provided for mobile users either directly to the motor vehicle or through a storage/fueling station 64. Finally, the hydrogen can be provided to any other type of hydrogen user 65. These hydrogen users 65 can include, but are not limited to, laboratories, chemical plants or even rocket engines.

The electrical power from the generators 11 is controlled by the renewable power controller 20. The invention allows the production of the maximum electrical output power 12 from the generators 11 by constraining it only as far as required by the electrolyzers 30. Unlike traditional systems, which constrain the voltage, power factor, frequency, etc. of the power generated to a typical value such as 480 VAC, 3 phase, 60 Hertz, the invention allows wider varying parameters. It should be noted that even though a traditional system may use transformers to adjust the generators voltage to meet the requirements of a power distribution system, the generators are restricted to very discrete operating parameters.

On the electrolyzer side, the invention makes similar improvements in efficiency. The electrical energy 12 is used to supply energy to the fans, heaters and pumps as well as the energy converter for the cells. As stated previously, this electrical energy is one of several discrete levels such as 240 VAC or 480 VAC operating at 60 Hz. Traditional systems use transformers, which are typically fairly highly efficient, to supply the proper voltage level to the peripheral devices like the pumps, etc. On the other hand, the larger portion of the energy is used by the electrolyzer energy converter and regulator which is much lower in efficiency. The invention's controller maximizes the energy efficiency from the renewable energy source 10 to the electrolyzer 30 because this path has the highest energy flow and the most potential for efficiency improvement of energy losses.

Overall renewable energy source 10 to hydrogen produced 40 efficiency improvements are accomplished by the renewable power controller 20. The controller receives operating parameter and renewable energy source data via the signal line 21. Similarly, the controller 20 receives electrolyzer operating conditions data through the signal line 22. Using an internal algorithm it sends signals to the generator(s) 11 to adjust its operating parameters to maximize the energy delivery to those required by the electrolyzer 30. A similar algorithm is used to send signals 22 to the electrolyzer 30 to adjust its operating conditions for maximum use of the generated electrical energy. Thus the invention maximizes the overall power throughput and hydrogen produced.

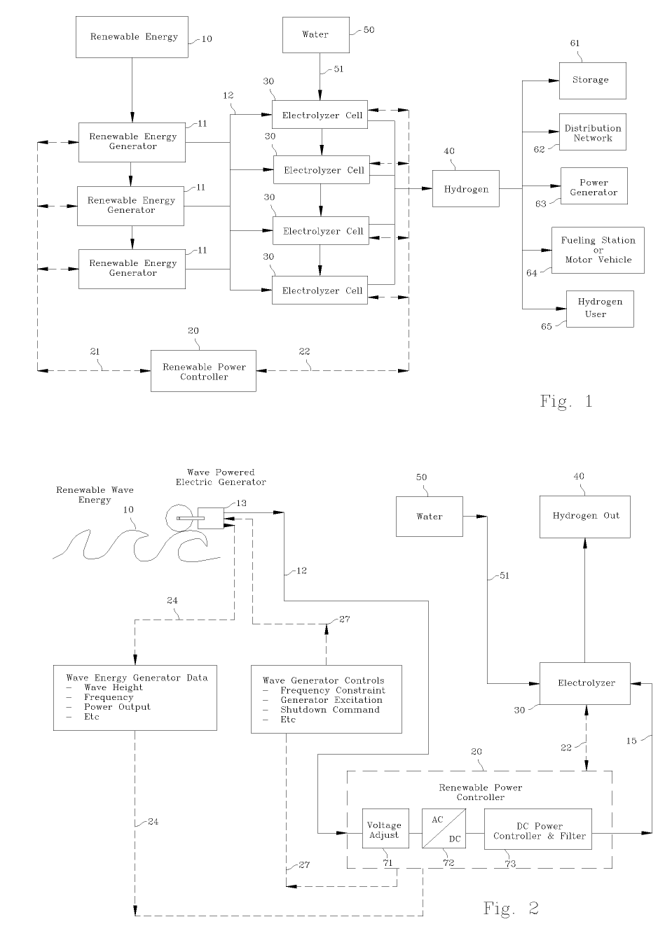

FIG. 2 depicts an embodiment of the invention having renewable energy source 10 supplied from ocean wave energy. The ocean waves provide mechanical energy to the wave powered electric generator 13 which in turn supplies electricity to the renewable power controller 20 via electric conduit 12. In this embodiment, the controller 20 conditions and regulates the electrical energy and through the conduit 15 it is provided to the electrolyzer 30. Water 50 is conveyed through conduit 51 to the electrolyzer where it is dissociated by the supplied electrical energy into hydrogen 40 and oxygen.

Referring to the diagram, information about the wave energy available such as wave height and frequency are measured by instrumentation in the wave generator 13 and conveyed to the renewable power controller 20 via signal 24. Other generator information such as generator output frequency, power output, generated voltage, etc. are also conveyed along signal line 24 from the generator 13 to the controller 20. Similar information from the electrolyzer instrumentation is conveyed down signal line 22. The information from these inputs is processed by an algorithm in the controller 20 and used to adjust electrolyzer 30 via signal line 22 and generator 13 via signal line 27. The results of the algorithm adjust the components of the system to optimize power throughput and hydrogen production. The algorithm sends commands or supervisory signals 27 to adjust such parameters as generator frequency constraints, generator excitation voltage level, shutdown commands, etc.

This embodiment depicts electrical energy passing through the renewable power controller from the generator 13 to the electrolyzer 30. The power controller conditions and regulates the electrical energy to maximize hydrogen 40 produced and to minimize the overall system losses. The renewable energy controller can include a means to adjust the voltage 71. It can also convert the AC power generated by the renewable electric generator to the DC power required by the electrolyzer cell using an AC/DC power converter 72. Then the DC electrical energy can be filtered to produce smooth DC power which is constantly adjusted by the DC controller 73 to meet the exact and optimal needs of the electrolyzers 30.

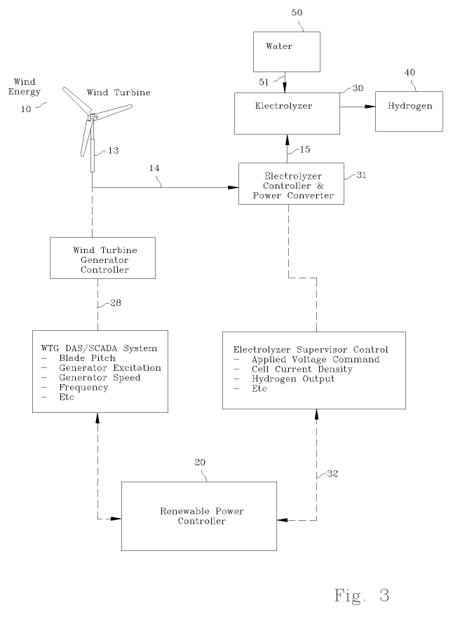

FIG. 3 depicts an embodiment of the invention having renewable energy source 10 supplied from wind energy. The wind turbine generator supplies electrical power 14 to the electrolyzer controller and power converter 31. The conditioned electrical power 15 is then delivered with water 50 via conduit 51 to the electrolyzer 30. Here the water is dissociated and hydrogen 40 is produced.

In this embodiment of the invention, supervisory monitoring and control of the generator and electrolyzer power system are shown in block diagram format. Most traditional wind turbine generators have some form of Data Acquisition System (DAS) or Supervisory Control and Data Acquisition (SCADA) System. The invention uses this existing system to monitor the wind/weather conditions as well as the WTG operating conditions and make changes to the WTG's adjustable parameters through signal line 28. These parameters include but are not limited to turbine blade pitch, generator excitation, generator speed, frequency, etc. Likewise, supervisory control is used to monitor and control the electrolyzer's controller and power converter 31 through signal line 32. The renewable power controller 20 monitors and controls such parameters as cell current density and hydrogen output and sends commands such as the voltage to apply to the electrolyzer cells, etc.

Thus, on the supply side, the invention allows improved overall performance by using renewable energy which is lost when the invention is not employed. For example, a traditional wind farm can not operate in low wind conditions. The wind turbine blades are feathered and renewable energy capture is stopped. The invention allows the turbine to continue generating electrical power even though it may not meet the strict requirements of the power grid. Also, the 60 Hz frequency requirements of a typical power grid require the generator blades to turn at a specific speed. The generator is not connected to the power grid until the blades are up to speed. The invention allows the generator to produce useable power while the blades are winding up to speed.

The generator side of the system offers areas for efficiency improvement by making use of energy which is normally abandoned due to the variable nature of renewable energy supplies. Oceans and wave energy systems cannot produce grid quality power when the water is calm. Likewise, solar based systems like photocells and solar furnaces cannot produce grid level power during clouding weather and at night. Wind turbines can not produce grid quality power when there is no wind or when the wind speeds are too high. Weather is variable by its nature and this in turn makes electric from renewables variable. The invention uses the energy normally lost because grid quality power can not be produced and turns it into usable hydrogen.

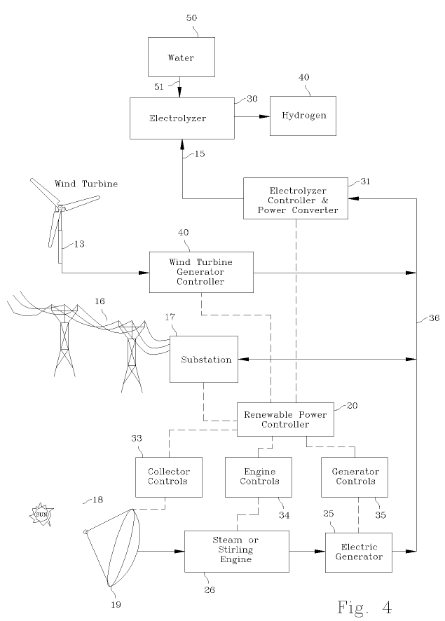

FIG. 4 depicts an embodiment of the invention having multiple renewable energy sources including a solar collector system 19 and a wind turbine generator 13. It also shows how excess or unused power can be supplied to the power grid 16. The power grid 16 is connected to a substation 17 which controls the flow of power. The renewable power controller 20 controls the substation 17 and either directs power from the grid to the internal grid or buss 36 where it is used to make hydrogen, or directs power from the renewable sources 13 and 19 to the power grid for use by other electric consumers. As in the previous example, wind power generated electric uses a wind turbine generator 13 which is controlled by its own wind turbine generator 40 that receives commands and supplies data to the renewable power controller 20.

In the case of solar energy 18, all components are controlled by the renewable energy controller 20 via their individual component controllers. The solar collector 19 gathers solar energy 18 and its collection process and tracking are controlled by the collector controller 33. The gathered solar energy drives the solar engine 26 which is controlled by the engine controls 34. The mechanical energy drives the generator 25 which is controlled by the generator controls 35.

All of the electrical energy from both renewable energy sources and the power grid are fed into the internal electrical buss 36. The buss 36 supplies electrical energy to the electrolyzer controller and power converter 31 which is in turn controlled by the renewable power controller 20. Conditioned electrical power 15 which is optimized for maximum efficiency and throughput is supplied to the electrolyzers 30. Here it dissociates water 50 which is supplied via conduit 51 to produce hydrogen 40.

Although this disclosure has described and illustrated certain embodiments of the invention, it is to be understood that the invention is not restricted to those particular embodiments. Rather, the invention includes all embodiments which are functionally or mechanically equivalent to the specific embodiments and features that have been described and illustrated herein.

What is claimed is:

1: A renewable power controller for a renewable energy system used to produce hydrogen from a renewable energy source,
said renewable power controller comprising a real time, dynamic overall renewable power controller which optimizes the characteristics of said renewable energy and renewable energy system, and which performs the functions of, communicates with or controls one or more of the following:
i. An external renewable generator controller means which modifies, provides control functions, and/or obtains data from one or more of the following; steering, cleaning, alignment, protection, weather, repair, renewal,
ii. A renewable energy generator controller means which modifies, provides control functions, and/or obtains data from one or more of the following; blade pitch, angle, frequency, phase and phase angle, current, voltage, frequency, power factor, power output, wave input, excitation, frequency constraints, wave height,
iii. A switchgear control means which modifies, provides control functions, and/or obtains data from one or more of the following; directing generated power to the grid, electrolysis equipment, or to another energy load, directs different quality power to different loads, directs different power busses to different loads, provides overload protection, provides energy direction,
iv. An electrolyzer power control means which modifies, provides control functions, and/or obtains data from one or more of the following; conversion of power either AC/DC or DC/DC, voltage, current, power, efficiency, temperature, pressure, flow rate, production,
v. An electrolyzer control means which modifies, provides control functions, and/or obtains data from one or more of the following; cooling, production, efficiency, voltage, aging, current demand, maximum output, cell current density, pressure, flow, overload, temperature, purity, power, feedwater,
vi. A hydrogen control means which modifies, provides control functions, and/or obtains data from one or more of the following; quality, de-oxification, storage, compression, temperature, pressure, dehumidification, pH, contamination,
vii. A social-economic control means which modifies, provides control functions, and/or obtains data from one or more of the following; current and historical price and demand for hydrogen, electricity and energy, social and political events which would effect any of these prices or demand factors, current and historical weather and natural disasters, market data,

2: A renewable power controller used to produce hydrogen as in claim 1 wherein said power controller controls the electric generator's adjustable parameters.

3: A renewable power controller used to produce hydrogen as in claim 1 wherein said power controller controls the flow of power from the generator to the converter.

4: A renewable power controller used to produce hydrogen as in claim 1 wherein said power controller controls the hydrogen converter's adjustable parameters.

5: A renewable power controller used to produce hydrogen as in claim 2 wherein said power controller directly controls adjustable parameters on the generator system.

6: A renewable power controller used to produce hydrogen as in claim 2 wherein said power controller commands changes to the adjustable parameters on the generator system.

7: A renewable power controller used to produce hydrogen as in claim 4 wherein said power controller directly controls adjustable parameters on the hydrogen converter system.

8: A renewable power controller used to produce hydrogen as in claim 4 wherein said power controller indirectly, via supervisory control, controls adjustable parameters on the hydrogen converter system.

9: A renewable power controller used to produce hydrogen as in claim 1 wherein said power controller receives electrical energy from the generator and conditions said electrical power for delivery to the hydrogen converter.

10: A renewable power controller used to produce hydrogen as in claim 1 wherein said renewable energy source is solar energy.

11: A renewable power controller used to produce hydrogen as in claim 1 wherein said renewable energy source is wind energy.

12: A renewable power controller used to produce hydrogen as in claim 1 wherein said renewable energy source is nuclear energy.

13: A renewable power controller used to produce hydrogen as in claim 1 wherein said renewable energy source is Bio-mass energy.

14: A renewable power controller used to produce hydrogen as in claim 1 wherein said renewable energy source is the energy of moving water.

15: A renewable power controller used to produce hydrogen as in claim 1 wherein said renewable energy source is geothermal energy.

16: A renewable power controller used to produce hydrogen as in claim 1 wherein said renewable energy source may consist of more than one type of renewable energy.

17: A renewable power controller used to produce hydrogen as in claim 1 wherein said renewable energy source(s) may be connected to the power grid.
